(19) United States
(12) Patent Application Publication
(10) Pub. No.: US 2007/0044147 A1
(43) Pub. Date: Feb. 22, 2007

(54) Apparatus and method for monitoring network using the parallel coordinate system

(75) Inventors: Hyun-Sang Choi, Changwon-si (KR); Hee-Jo Lee, Seoul (KR)

Correspondence Address: ST. ONGE STEWARD JOHNSTON & REENS, LLC, 986 BEDFORD STREET, STAMFORD, CT, 06905-5619, US

(73) Assignee: Korea University Industry and Academy Collaboration Foundation

(21) Appl. No.: 11/324,698

(22) Filed: Jan. 3, 2006

(30) Foreign Application Priority Data
Aug. 17, 2005 (KR) 10-2005-0075223

(51) Int. Cl. G06F 15/16

(52) U.S. Cl. 726/12

(57) ABSTRACT

A network monitoring apparatus collects packets of a first network, and generates visual information by displaying the packets on a parallel coordinate system which has one or more parallel axis for parameters of the packets. The network monitoring apparatus may extract attack packets from the packet, and the network monitoring apparatus may transmit the visual information to a remote server. Through the network monitoring apparatus, the network manager can visually grasp the state of the network or the existence of a network attack.

### CROSS-REFERENCE TO RELATED APPLICATIONS

This application claims priority to and the benefit of Korean Patent Application 10-2005-0075223 filed in the Korean Intellectual Property Office on Aug. 17, 2005, the entire content of which is incorporated herein by reference.

### FIELD OF THE INVENTION

The present invention relates to an apparatus and a method for monitoring a network. More specifically, the present invention relates to a monitoring apparatus and a monitoring method for grasping a network state visually.

### BACKGROUND OF THE INVENTION

With the growth of the Internet and the rapid increment of users, today's networks are full of complex and various traffic. Therefore, it is not easy to detect malignant traffic from the massive amount of traffic.

The malignant traffic includes scanning attacks, denial-of-service(DoS) attacks, and Internet worms.

Scanning attacks are activities for searching for weak points of systems or networks, etc. Scanning attacks include port scanning attacks, host scanning attacks, etc. Port scanning attacks are activities for searching for open ports of a host computer, and host scanning attacks are activities for searching for attackable host computers.

DoS attacks are activities for keeping normal users from using services of a system or a network by possessing exclusively resources of the system or the network. Generally DoS attacks prevent the access of normal users by overloading the system or the network by providing a great deal of unnecessary information. DoS attacks include source-spoofed DoS attacks, multi-port DoS attacks, network-directed DoS attacks, etc. Source-spoofed DoS attacks are activities for making a server unavailable or out-of-order by providing excessive information to the server, and they make it difficult to detect a attacking server and the existence of attacks by deceiving of a source IP address. Multi-port DoS attacks are activities for making a server unavailable or overloaded by varying the source IP address and by providing the server with excessive information which have the various port numbers and the various source IP addresses. Network-directed DoS attacks are activities for making the network unavailable by providing the network with excessive information which has the various source IP addresses, the various destination IP addresses, the various port numbers, etc. The Internet worms are malignant codes that transfer themselves to an unspecified destination. The traffic data of Internet worms are similar to that of the host scanning attacks, but while the size of packets of the host scanning attacks is generally 40 bytes or 48 bytes, the size of packets of the Internet worms is larger than 48 bytes. This is because packets of the host scanning attacks generally consist of a header and don't comprise a body, but packets of the Internet worms comprise a header and a body. The Internet worms have definite size according to the type.

In addition, special traffic such as backscatter, which is not actually an attack but is caused by other attacks, exists. Backscatter consists of response packets that the destination server generates against the distributed DoS attacks. The backscatter has a peculiar pattern with one source IP address, many destination IP addresses, and one or more port numbers.

The malignant traffics like this cause inconvenience to the user of the network, and take the majority of bandwidth. Therefore much research on easy detection of the malignant traffic is proceeding.

Specifically, Korean Published Patent Application No. 10-2004-0072365 introduces a method for displaying a state of a network using 3-dimension orthogonal graphs. But it is difficult to use the method, because it is not easy to make 3-dimension orthogonal graphs. In addition, because 3-dimensional figures are displayed in a 2-dimension plane, it is not easy to grasp the state of the network. Moreover, because a 3-dimension orthogonal graph has only 3 axes, only 3 parameters are used for grasping the state of the network.

### SUMMARY OF THE INVENTION

The present invention has been made in an effort to provide a monitoring apparatus and a monitoring method for visually grasping a state of a network.

A network monitoring apparatus for monitoring a first network, according to an exemplary embodiment of the present invention, includes a network packet collector, and a visual information generator. The network packet collector collects packets of the first network and the visual information generator generates visual information by displaying the packets on a parallel coordinate system which has at least two parallel axes for parameters of the packets.

A network monitoring method for monitoring a first network according to an exemplary embodiment of the present invention includes collecting packets of the first network, and generating visual information by displaying the packets on a parallel coordinate system which has at least two parallel axes for parameters of the packets.

A network analyzing apparatus for analyzing a first network according to an exemplary embodiment of the present invention includes a network packet collector, at least two parameter storages, and an attack type identifier generator. The network packet collector collects packets of the first network, the parameter storages store the same value only once, and the attack type identifier generator generates an attack type identifier of a packet according to whether or not the value of each parameter of the packet is already stored in the parameter storages.

An attack type identifying method for identifying an attack type of a packet on a first network according to an exemplary embodiment of the present invention includes collecting packets of the first network, and generating an attack type identifier of a packet according to whether or not the value of each parameter of the packet is already stored in parameter storages in which the same value is stored only once.

A packet classifying method for classifying packets on a first network by attack types according to an exemplary embodiment of the present invention includes collecting packets of the first network, generating an attack type identifier of a packet according to whether or not the value of each parameter of the packet is already stored in parameter storages in which the same value is stored only once, and storing the packet in an attack packet storage according to the attack type identifier.

### BRIEF DESCRIPTION OF THE DRAWINGS

FIG. 1 is shows a network environment in which a network monitoring apparatus according to an exemplary embodiment of the present invention is installed.

FIG. 2 is a block diagram of a network monitoring apparatus according to an exemplary embodiment of the present invention.

FIG. 3 shows an example of a four-dimensional parallel coordinate system.

FIG. 4 is a block diagram for an attack packet extractor according to an exemplary embodiment of the present invention.

FIG. 5 is a block diagram for a network monitoring apparatus according to an exemplary embodiment of the present invention.

FIG. 6 is a drawing of visual information of a source-spoofed DoS attack according to an exemplary embodiment of the present invention.

FIG. 7 is a drawing of visual information of a port scanning attack according to an exemplary embodiment of the present invention.

FIG. 8 is a drawing of visual information of a host scanning attack according to an exemplary embodiment of the present invention.

FIG. 9 is a drawing of visual information of a worm according to an exemplary embodiment of the present invention.

FIG. 10 is a drawing of patterns and divergences of visual informations according to variable attack types.

FIG. 11 is a block diagram of a network analysis apparatus according to an exemplary embodiment of the present invention.

FIG. 12 is a flowchart of a network monitoring method according to an exemplary embodiment of the present invention.

FIG. 13 shows a method for extracting attack packets according to an exemplary embodiment of the present invention.

FIG. 14 shows a method for identifying an attack type of network packets according to an exemplary embodiment of the present invention.

FIG. 15 shows a method for classifying network packets according to an exemplary embodiment of the present invention.

### DETAILED DESCRIPTION OF THE INVENTION

An exemplary embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. In addition, the drawings and description are to be regarded as illustrative in nature and not restrictive, and like reference numerals designate like elements throughout the specification.

Throughout this specification and the claims that follow, unless explicitly described to the contrary, the word “comprise” or variations such as “comprises” or “comprising” will be understood to imply the inclusion of stated elements but not the exclusion of any other elements.

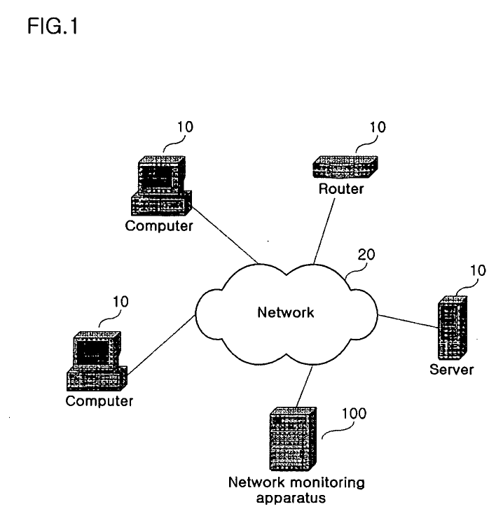

A network environment in which a network monitoring apparatus according to an exemplary embodiment of the present invention is installed will now be described with reference to FIG. 1.

FIG. 1 shows a network environment in which a network monitoring apparatus according to an exemplary embodiment of the present invention is installed.

As shown in FIG. 1, a network environment in which a network monitoring apparatus according to an exemplary embodiment of the present invention is installed includes a network apparatus 10, a network 20, and a network monitoring apparatus 100.

The network apparatus 10 includes a computer, a router, and a server.

The network 20 is a network for exchanging information between network apparatuses 10 or between the network apparatus 10 and the network monitoring apparatus 100. The network 20 may be a wire network and a wireless network. For example, the network 20 may be a wireless local area network(WLAN), a TCP/IP(transmission control protocol/Internet protocol) network, or a Bluetooth network. Hereinafter, the network 20 will be regarded as a TCP/IP network.

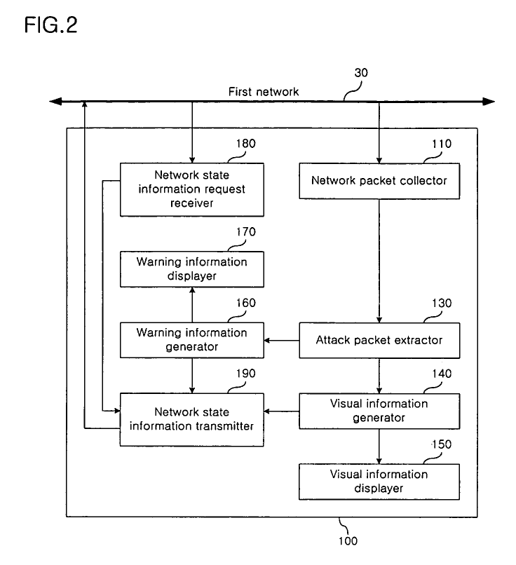

The network monitoring apparatus according to an exemplary embodiment of the present invention will now be described with reference to FIG. 2 to FIG. 4.

FIG. 2 is a block diagram of a network monitoring apparatus 100 according to an exemplary embodiment of the present invention.

As shown in FIG. 2, the network monitoring apparatus 100 according to an exemplary embodiment of the present invention monitors a first network 30, and comprises a network packet collector 110, an attack packet extractor 130, a visual information generator 140, a visual information displayer 150, a warning information generator 160, a warning information displayer 170, a network state information request receiver 180, and a network state information transmitter 190.

The network packet collector 110 collects packets of the first network 30, and the network packet collector 110 may collect flows of the first network 30. A flow is defined as IP traffic with the same source address, destination address, source port and destination port. A router will output a flow when it determines that the flow is finished, so the network packet collector 110 may receive a flow from the router. If the network monitoring apparatus 100 monitors a network with the flow, it may rapidly analyze the network and be connected to usual apparatuses such as routers. Therefore, a packet herein includes a flow.

The attack packet extractor 130 extracts attack packets from the packets that the network packet collector 110 collects. The attack packet extractor 130 may extract packets that are regarded as attack packets, and it may collect the extracted attack packets according to the type of attack. When the attack packet extractor 130 collects more than a predetermined quantity of attack packets for unit time, it may provide the attack packets to the visual information generator 140 according to the type of attack. The unit time may be predetermined and changed by a network manager. The attack packets include worm packets, host scanning attack packets, port scanning attack packets, source-spoofed DoS attack packets, multi-port DoS attack packets, backscatter packets, and distributed host scanning attack packets.

The visual information generator 140 generates visual information by displaying the attack packets on the parallel coordinate system. The visual information generator 140 may be provided with one type of attack packets by the attack packet extractor 130 and generate visual information. In this case, the visual information has different patterns according to the type of attack. The visual information generator 140 may be provided with packets by the network packet collector 110, and the visual information generated in this case shows the network state when the network packet collector 110 collects packets of the first network 30. Each of axes in the parallel coordinate system indicates the parameter included in the attack packets such as the source address, the destination address, the destination port, and the packet size. In exemplary embodiments of the present invention, the parallel coordinate system has an axis of the source address, an axis of the destination address, an axis of the destination port, and an axis of the packet size. However, in various modified embodiments, the parallel coordinate system may exclude one or more axes, and may include one or more axes for other parameters, such as TCP flags and TTL field of TCP/IP header.

The parallel coordinate system is a coordinate system that has two or more parallel axes. A vector on the orthogonal coordinate system is a point, but a vector on the parallel coordinate system is a bent line. While it is difficult or impossible to input four or more axes into the orthogonal coordinate system, it is very easy to input additional axes into the parallel coordinate system.

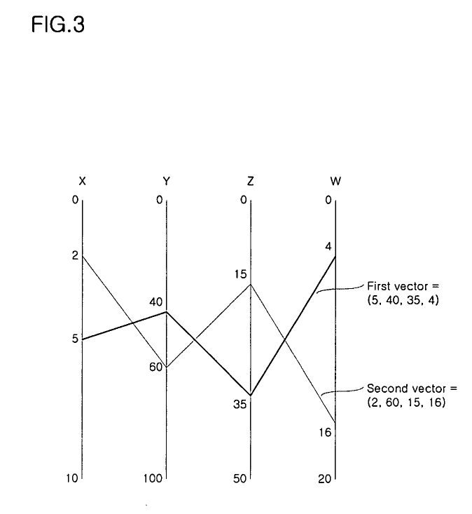

FIG. 3 shows an example of a four-dimensional parallel coordinate system.

The parallel coordinate system of FIG. 3 includes four axes, i.e., an X-axis, a Y-axis, a Z-axis, and a W-axis. It includes first vector(5, 40, 35, 4) and second vector(2, 60, 15, 16). As shown in FIG. 3, each of the vectors on the parallel coordinate system is a bent line made by connecting points. As shown in FIG. 3, it is possible to input four or more axes into the parallel coordinate system.

Again the description about FIG. 2 will continue.

The visual information displayer 150 as shown in FIG. 2 displays the visual information on a display device such as a cathode ray tube(CRT), a liquid crystal display(LCD), and a plasma display panel(PDP).

The attack packet extractor 130 determines whether the attack packets exist, and provides attack packet existence information to the warning information generator 160. The warning information generator 160 receives the attack packet existence information and generates warning information.

The warning information displayer 170 receives the warning information generated by the warning information generator 160, and displays it. The warning information displayer 170 indicates the warning information through a display device or a speaker. The warning information displayer 170 informs the network manager about the existence of the attack packets, so the network manager can rapidly deal with the attack.

The network state information request receiver 180 receives a network state information request to request state information of first network 30 from a remote apparatus through the first network 30.

When the network state information transmitter 190 receives the network state information request from the network state information request receiver 180, it transmits the warning information from the warning information generator 160 and/or the visual information from the visual information generator 140 to a remote apparatus through the first network 30. The network manager may thereby monitor the state of the first network 30 using the remote apparatus.

Even if the network state information transmitter 190 does not receive a network state information request, it may still determine whether the attack packets exist and transmit the warning information and/or the visual information to the remote apparatus. Therefore the network manager can rapidly deal with the attack.

Particularly if the network monitoring apparatus 100 is a HTTP server, the network manager may monitor the state of the network through the Internet browser installed in the remote apparatus.

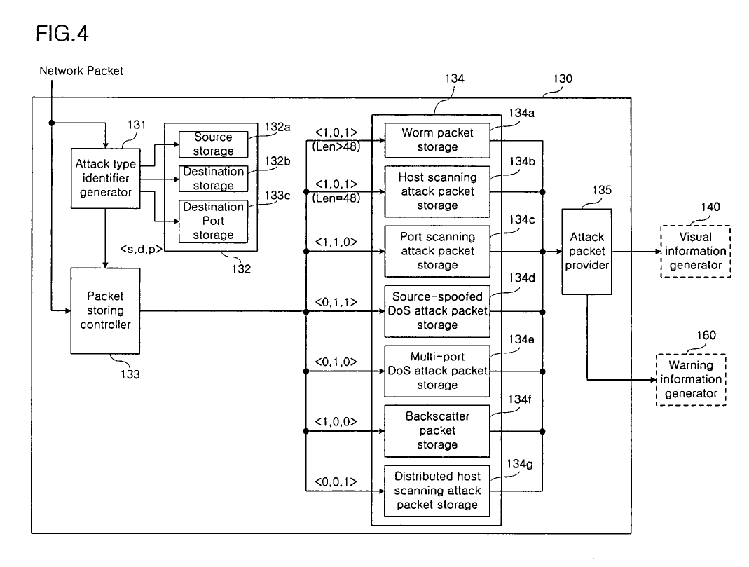

An attack packet extractor 130 will now be described with reference to FIG. 4.

FIG. 4 is a block diagram for an attack packet extractor according to an exemplary embodiment of the present invention.

As shown in FIG. 4, the attack packet extractor 130 comprises an attack type identifier generator 131, a parameter storage 132, a packet storing controller 133, an attack packet storage 134, and an attack packet provider 135.

The attack type identifier generator 131 receives packets and stores the value of parameters of the packets in the parameter storage 132.

The parameter storage 132 is a storage in which the same value is stored only once. The structure of the parameter storage 132 includes a linked list, a binary search tree, a MULTOPS(MUlti-Level Tree for Online Packet Statistics), and a hash table. As shown in FIG. 4, the parameter storage 132 comprises a source storage 132a, a destination storage 132b, and a destination port storage 133c. The source storage 132a is a storage in which the source address of packets is stored, the destination storage 132b is a storage in which the destination address is stored, and the destination port storage 133c is a storage in which the destination port is stored. The attack type identifier generator 131 receives packets and stores the source address of the packets in the source storage 132a, the destination address of the packets in the destination storage 132b, and the destination port of the packets in the destination port storage 133c. In this case, the attack type identifier generator 131 generates an attack type identifier according to whether or not the value of each parameters already exists in the parameter storage 132. In an exemplary embodiment of the present invention, the form of the attack type identifier is defined as <s, d, p>. “s” is the value according to whether or not the source address exists in the source storage 132a, “d” is the value according to whether or not the destination address exists in the destination storage 132b, and “p” is the value according to whether or not the destination port exists in the destination port storage 132c. In an exemplary embodiment of the present invention, if the source address exists in the source storage 132a, “s” is defined as 1, and if the source address does not exist in the source storage 132a, “s” is defined as 0. “d” and “p” is similarly defined. If the attack type identifier generator 131 stores the source address, the destination address, and the destination port of one packet in the parameter storage 132, and the source address and the destination address of the packet are already stored in the parameter storage 132, the attack type identifier generator 131 generates an attack type identifier such as <1, 1, 0>.

In addition, the attack type identifier generator 131 may have a period for maintaining the value of parameters. The attack type identifier generator 131 may clear the parameter storage 132 when the period has expired, and because the parameter storage 132 doesn't hold the parameter values for a long time, the attack type identifier generator 131 can evaluate the type of attack more accurately.

The network packets are stored in the attack packet storage 134 according to the type of attack. The attack packet storage 134 includes a worm packet storage 134a, a host scanning attack packet storage 134b, a port scanning attack packet storage 134c, a source-spoofed DoS attack packet storage 134d, a multi-port DoS attack packet storage 134e, a backscatter packet storage 134f, and a distributed host scanning attack packet storage 134g. Packets that are judged to be worm packets are stored in the worm packet storage 134a, packets that are judged to be host scanning attack packets are stored in the attack packet storage 134b, packets that are judged to be port scanning attack packets are stored in the port scanning attack packet storage 134c, and packets that are judged to be source-spoofed DoS attack packets are stored in the source-spoofed DoS attack packet storage 134d.

Packets that are judged to be multi-port DoS attack packets are stored in the multi-port DoS attack packet storage 134e, packets that are judged to be backscatter packets are stored in the backscatter packet storage 134f, and packets that are judged to be distributed host scanning attack packets are stored in the distributed host scanning attack packet storage 134g.

The packet storing controller 133 judges the type of attack with the attack type identifier, and stores packets in the attack packet storage 134 according to the attack type identifier. For example, if the attack type identifier of one packet is <1,1,0>, the packet storing controller 133 judges the attack type of the packet to be the port scanning attack, and stores the packet in the attack packet storage 134c. If the attack type identifier of another packet is <1,0,1> and the size of the packet is larger than 48 bytes, the packet storing controller 133 judges the attack type of the packet to be a worm attack, and stores the packet or the parameters of the packet in the worm packet storage 134a.

Additionally, the packet storing controller 133 may have a period for extracting the attack packets. The packet storing controller may clear the attack packet storage 134 at the expiration of the period. Because the attack packet storage 134 holds the attack packets for a fixed time, the attack packet extractor 130 can extract the attack packets more effectively. If the attack packet storage 134 stores the attack packets for a long period of time, because various types of attack packets are stored in the attack packet storage 134, the attack packet extractor 130 can extract packets of mixed attacks.

If the attack packet storage 134 has more than a predetermined number of packets, the attack packet provider 135 judges the first network 30 to have attack packets and provides information about the attack packets to the visual information generator 140. For example, when the multi-port DoS attack packet storage 134e has 50 packets, the attack packet provider 135 judges the first network 30 to have the multi-port DoS attack packets and provides information about the attack packets to the visual information generator 140. In this case, the visual information generator 140 displays the provided information on the parallel coordinate system, and generates the visual information.

The attack packet provider 135 may provide the information about the existence of the attack packets to the warning information generator 160. If the multi-port DoS attack packet storage 134e has more than 50 packets, the attack packet provider 135 judges the first network 30 to be under a multi-port DoS attack, and provides the information about the attack to the warning information generator 160. In this case, the warning information generator 160 generates the warning information about the existence of the multi-port DoS attack, and provides the warning information to the warning information displayer 170 or the network state information transmitter 190. If the warning information displayer 170 receives the warning information, it can inform of the existence of the network attack to a network manager through a display device or a speaker. The network state information transmitter 190 can also inform of the existence of the network attack to a remote network manager by transmitting the warning information to the first network 30.

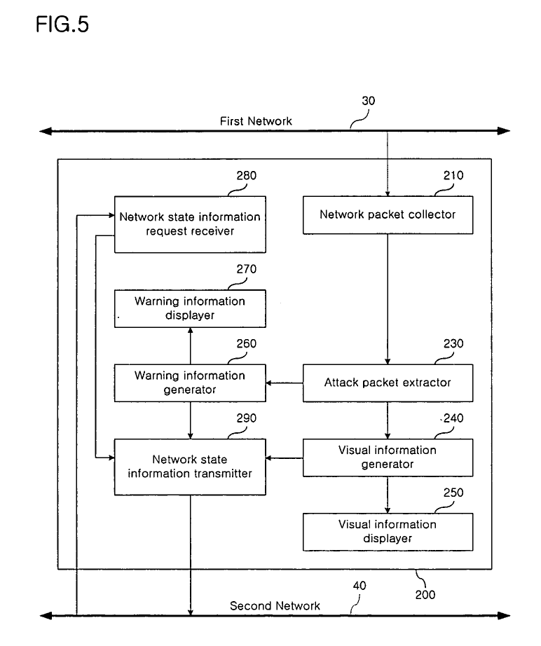

A network monitoring apparatus 200 according to an exemplary embodiment of the present invention will now be described with reference to FIG. 5.

FIG. 5 is a block diagram of a network monitoring apparatus according to an exemplary embodiment of the present invention.

As shown in FIG. 5, the network monitoring apparatus 200 according to an exemplary embodiment of the present invention monitors the first network 30, and comprises a network packet collector 210, an attack packet extractor 230, a visual information generator 240, a visual information displayer 250, a warning information generator 260, a warning information displayer 270, a network state information request receiver 280, and a network state information transmitter 290.

Because the elements 210 to 270 of the network monitoring apparatus 200 of FIG. 5 are the same as elements 110 to 170 of the network monitoring apparatus 100 of FIG. 2, a description of elements 210 to 270 will be omitted.

The network state information request receiver 280 receives a network state information request to request states of the first network 30 from a remote apparatus through the second network 40.

If the network state information transmitter 290 receives a network state information request, it transmits the warning information from the warning information generator 260 and/or the visual information from the visual information generator 240 to a remote apparatus through the second network 40. Therefore, a network manager can monitor the state of the remote first network 30, and even if the first network 30 is unavailable because of network attack, the first network 30 can be monitored through the second network 40. The second network 40 includes the wire network, and the wireless network. If the second network 40 is more stable than the first network 30, the network manager can monitor the first network 30 more effectively.

Even if the network state information transmitter 290 does not receive a network state information request, it may determine whether the attack packets exist and transmit the warning information and/or the visual information to the remote apparatus. Therefore the network manager can rapidly deal with the attack.

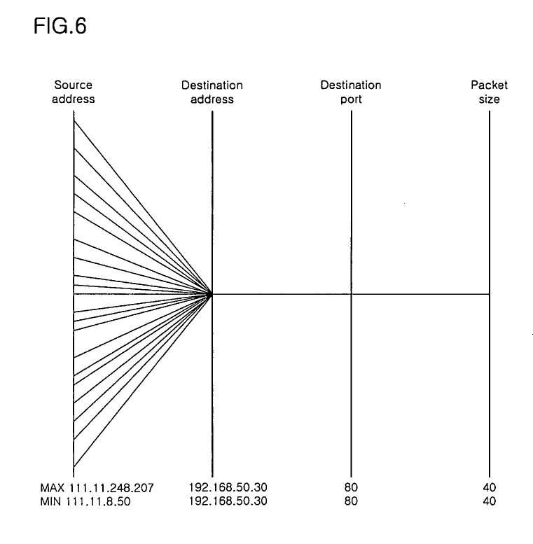

Various examples of the visual information according to the type of attack will now be described in relation to FIG. 6 to FIG. 10. In exemplary embodiments of the present invention, the parallel coordinate system for the visual information has an axis of the source address, an axis of the destination address, an axis of the destination port, and an axis of the packet size.

FIG. 6 is a drawing for visual information of a source-spoofed DoS attack according to an exemplary embodiment of the present invention. The source-spoofed DoS attack drawn on FIG. 6 has source addresses from 111.11.8.50 to 111.11.248.207, a destination address of 192.168.50.30, a destination port of 80, and an average packet size of 40 bytes.

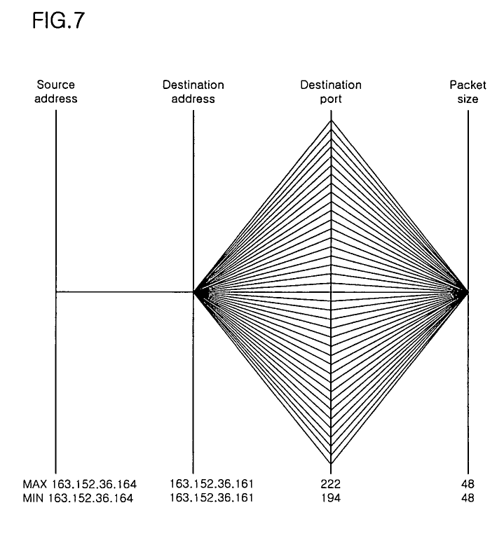

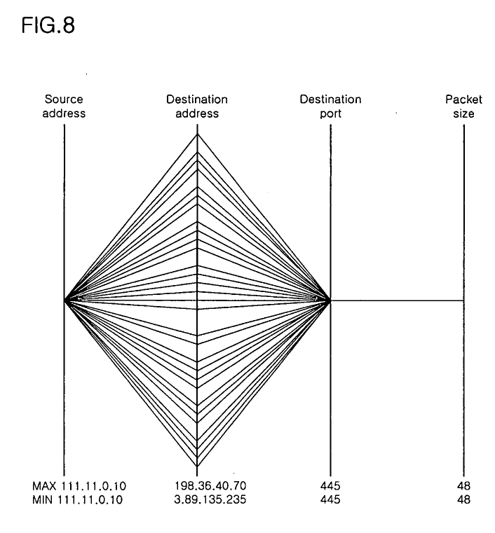

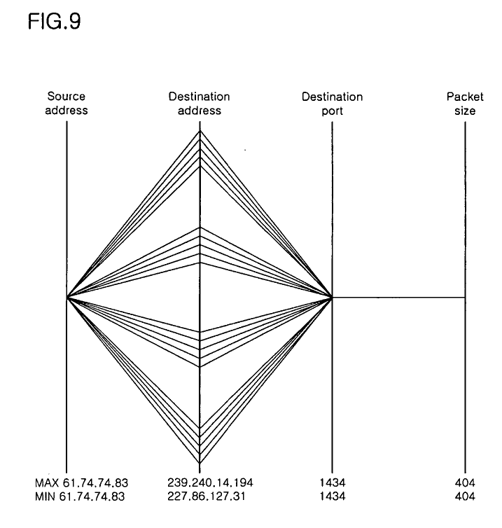

FIG. 7 is a drawing for visual information of a port scan attack according to an exemplary embodiment of the present invention, FIG. 8 is a drawing for visual information of a host scan attack according to an exemplary embodiment of the present invention, and FIG. 9 is a drawing for visual information of a worm according to an exemplary embodiment of the present invention.

As shown in FIG. 6 to FIG. 9, the visual information has different configurations according to the type of attack. Therefore, the network manager can easily grasp the type of attack in the network.

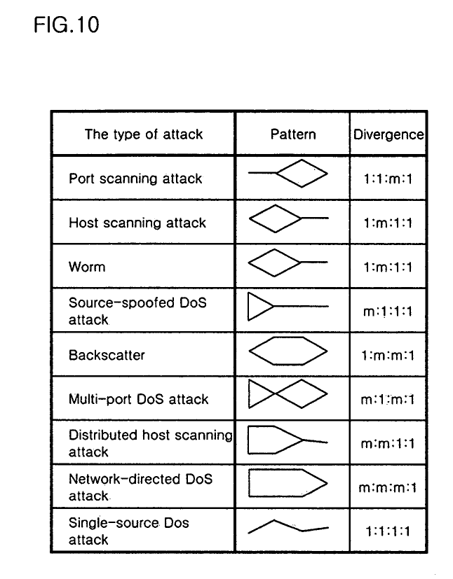

FIG. 10 is a drawing of patterns and divergences of visual informations according to various attack types.

As shown in FIG. 10, the attacks of the network have different patterns according to type. Therefore, the network manager can easily grasp the type of attack in the network.

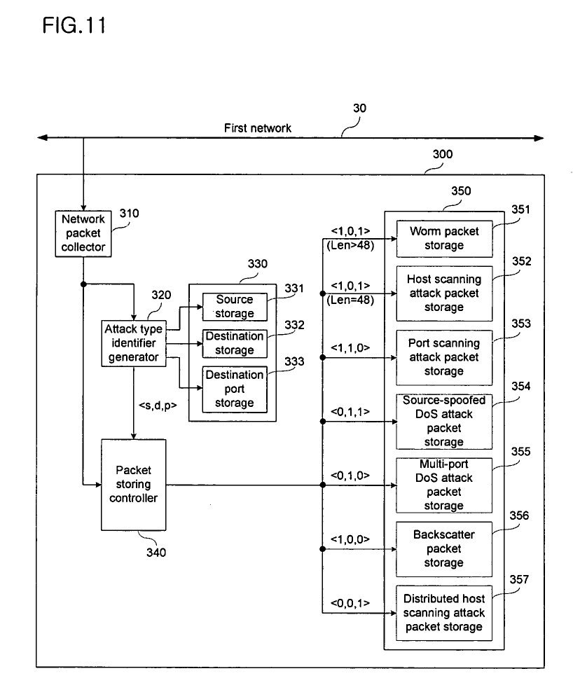

The network analysis apparatus 300 according to an exemplary embodiment of the present invention will now be described with reference to FIG. 11.

FIG. 11 is a block diagram of a network analysis apparatus 300 according to an exemplary embodiment of the present invention.

As shown in FIG. 11, a network analysis apparatus 300 analyzes packets in the first network 30, and comprises a network packet collector 310, an attack type identifier generator 320, a parameter storage 330, a packet storing controller 340, and an attack packet storage 350.

The network packet collector 310 collects packets in the first network 30.

The attack type identifier generator 320 generates an attack type identifier with the packets that the network packet collector 310 collects. Because the attack type identifier generator 320 is the same as the attack type identifier generator 131 in FIG. 4, a detailed description thereof will be omitted.

And because elements 330 to 350 of the network analysis apparatus 300 of FIG. 11 are the same as elements 132 to 134 of FIG. 4, a description thereof will be omitted.

The network analysis apparatus 300 can easily classify suspicious packets according to the type of attack. The packets that are classified by the network analysis apparatus 300 are used in the various analyses.

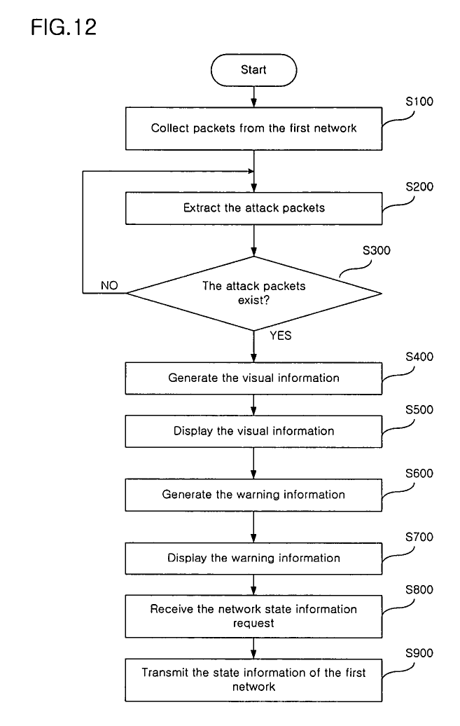

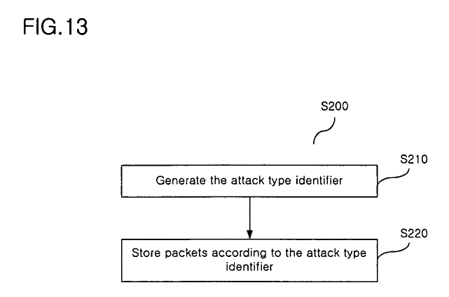

A network monitoring method according to an exemplary embodiment of the present invention will now be described with reference to FIG. 12 and FIG. 13.

FIG. 12 is a flowchart of a network monitoring method according to an exemplary embodiment of the present invention, and FIG. 13 shows a method for extracting attack packets according to an exemplary embodiment of the present invention.

Firstly, to monitor the first network 30, the network packet collector 110 collects packets of the first network 30 in step S100.

The attack packet extractor 130 then extracts attack packets from the packets that the network packet collector 110 collects in step S200. Cconcretely, the attack type identifier generator 131 generates an attack type identifier according to whether or not the value of each parameter of the attack packets already exists in the parameter storage 132 in step S210. After that, the packet storing controller 133 determines the type of attack with the attack type identifier, and stores packets in the attack packet storage 134 according to the attack type identifier in step S220.

If the attack packets that the attack packet extractor 130 extracts exist in step S300, the visual information generator 140 generates visual information by displaying the attack packets on the parallel coordinate system in S400.

The visual information displayer 150 then displays the visual information on a display device in S500. With this, the network manager can visually grasp the state of the first network 30 by using the network monitoring apparatus 100. Moreover, the network manager can recognize the existence of the attack in the first network 30. Even when an attack with new pattern appears, the network manager can easily recognize the existence of the new attack.

The warning information generator 160 receives the attack packet existence information from the attack packet extractor 130 and generates warning information in step S600.

After that, the warning information displayer 170 indicates the warning information through a display device or a speaker in step S700. With this, even though the network manager does not analyze the visual information, the existence of the attack can be rapidly recognized.

If the network state information request receiver 180 receives the network state information request from the remote server in step S800, the network state information transmitter 190 transmits the warning information or the visual information to the remote server in S900. With this, the network manager can grasp the state of the first network 30 from a remote place.

Even if the network state information request receiver 180 has not received a network state information request from the remote server, the network state information transmitter 190 may transmit the warning information or the visual information to the remote server in step S900. In particular, in case of existence of attack packets, the network state information transmitter 190 may transmit the warning information or the visual information to the remote server. With this, even if the network manager has not requested the state information to the network monitoring apparatus 100, the state of the first network 30 can be grasped.

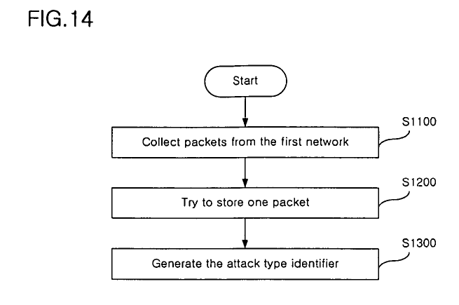

A method for identifying an attack type of network packets according to an exemplary embodiment of the present invention will now be described with reference to FIG. 14.

FIG. 14 shows a method for identifying an attack type of network packets according to an exemplary embodiment of the present invention.

To identify the attack type of the packets of the first network 30, the network packet collector 310 collects packets from the first network 30 in step S1100.

Next, the attack type identifier generator 320 tries to store one packet that is collected by the network packet collector 310 in the parameter storage 330 in step S1200.

The attack type identifier generator 320 generates an attack type identifier according to whether or not the value of each parameters of the packet already exists in the parameter storage 132 in step S1300.

According to the method for identifying an attack type of network packets of an exemplary embodiment of the present invention, many packets can be classified according to the type of attack, and visual information with various formats can be generated.

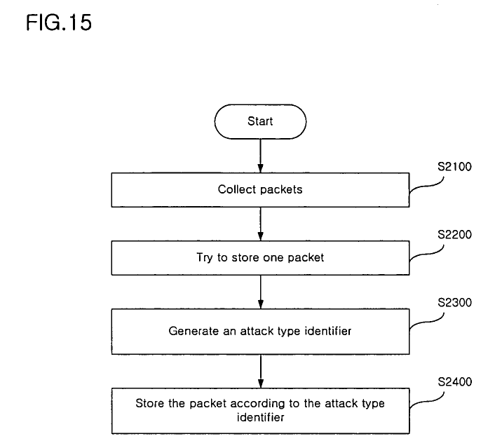

A method for classifying network packets according to an exemplary embodiment of the present invention will now be described with reference to FIG. 15.

FIG. 15 shows a method for classifying network packets according to an exemplary embodiment of the present invention.

To classify packets of the first network 30 according to the type of attack, the network packet collector 310 collects packets from the first network 30 in step S2100.

The attack type identifier generator 320 tries to store one packet that is collected by the network packet collector 310 in the parameter storage 330 in step S2200.

After that, the attack type identifier generator 320 generates an attack type identifier according to whether or not the value of each parameter of the packet already exists in the parameter storage 132 in step S2300.

The packet storing controller 340 then stores the packet in the attack packet storage 134 according to the attack type identifier in step S2400.

According to the method for classifying network packets of an exemplary embodiment of the present invention, the packet storing controller 340 stores packets in the attack packet storage 134 according to the type of attack, and the network manager can analyze the classified packets in detail. Moreover, many packets can be classified according to the type of attack, and visual informations with various formats can be generated.

According to the present invention, the network manager can visually grasp the state of the network or the existence of a network attack. Further, it is easy to add one or more parameters for analyzing the network. Moreover, according to the present invention, even when an attack with a new pattern appears, the network manager can easily recognize the existence of the new attack.

According to the present invention, many packets can be classified according to the type of attack, and the network manager can analyze the classified packets in detail.

The above-described methods and apparatuses are not only realized by the exemplary embodiment of the present invention, but, on the contrary, are intended to be realized by a program for realizing functions corresponding to the configuration of the exemplary embodiment of the present invention or a recoding medium recoding the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A network monitoring apparatus for monitoring a first network, comprising:
a network packet collector collecting packets of the first network; and
a visual information generator generating visual information by displaying the packets on a parallel coordinate system which has at least two parallel axes for parameters of the packets.

2. The network monitoring apparatus of claim 1, further comprising an attack packet extractor extracting attack packets from the packets, wherein the visual information generator generates the visual information with the attack packets.

3. The network monitoring apparatus of claim 2, wherein the attack packet extractor comprises:
at least two parameter storages in which the same value is stored only once;
an attack type identifier generator generating an attack type identifier of a packet according to whether or not the value of each parameters of the packet is already stored in the parameter storages;
at least one attack packet storage in which packets are stored according to types of attack;
a packet storing controller storing the packet in the attack packet storage according to the attack type identifier; and
an attack packet provider providing packets of the attack packet storage to the visual information generator in case the attack packet storage has more packets than a predetermined number.

4. The network monitoring apparatus of claim 3, wherein the parameter storages is cleared after a predetermined time period elapses.

5. The network monitoring apparatus of claim 3, wherein the attack packet storage is cleared after a predetermined time period elapses.

6. The network monitoring apparatus of claim 2, further comprising:
a warning information generator generating warning information in a case that the attack packets exist; and
a network state information transmitter transmitting the warning information to a remote apparatus through the first network.

7. The network monitoring apparatus of claim 2, further comprising:
a warning information generator generating a warning information in a case that the attack packets exist; and
a network state information transmitter transmitting the

8. The network monitoring apparatus of claim 1, further comprising:
a network state information transmitter transmitting the visual information to a remote apparatus through the first network.

9. The network monitoring apparatus of claim 1, further comprising:
a network state information request receiver receiving a network state information request to request states of the first network through the first network; and
a network state information transmitter transmitting the visual information to a remote apparatus through the first network in response to the network state information request.

10. The network monitoring apparatus of claim 1, further comprising:
a network state information transmitter transmitting the visual information to a remote apparatus through a second network.

11. The network monitoring apparatus of claim 1, further comprising:
a network state information request receiver receiving a network state information request to request states of the first network through a second network; and
a network state information transmitter transmitting the visual information to a remote apparatus through the second network in response to the network state information request.

12. The network monitoring apparatus of claim 1, further comprising: a visual information displayer displaying the visual information in a display device.

13. A network monitoring method for monitoring a first network, comprising:
collecting packets of the first network; and
generating visual information by displaying the packets on a parallel coordinate system which has one or more parallel axes for parameters of the packets.

14. The network monitoring method of claim 13, further comprising extracting attack packets from the packets of the first network, wherein generating the visual informaion comprises generating the visual information by displaying the attack packets.

15. The network monitoring method of claim 14, wherein extracting the attack packets comprises:
generating an attack type identifier of a packet according to whether or not the value of each parameter of the packet is already stored in parameter storages in which the same value is stored only once; and
storing the packet in an attack packet storage according to the attack type identifier.

16. The network monitoring method of claim 15, wherein the parameter storages are cleared after a predetermined time period elapses.

17. The network monitoring method of claim 15, wherein the attack packet storage is cleared after a predetermined time period elapses.

18. The network monitoring method of claim 14, further comprising: generating warning information in a case that the attack packets exist; and transmitting the warning information to a remote apparatus through the first network.

19. The network monitoring method of claim 14, further comprising: generating a warning information in a case that the attack packets exist; and transmitting the warning information to a remote apparatus through a second network.

20. The network monitoring method of claim 13, further comprising transmitting the visual information to a remote apparatus through the first network.

21. The network monitoring method of claim 13, further comprising:
receiving a network state information request to request states of the first network through the first network; and
transmitting the visual information to a remote apparatus through the first network in response to the network state information request.

22. The network monitoring method of claim 13, further comprising transmitting the visual information to a remote apparatus through a second network.

23. The network monitoring method of claim 13, further comprising:
receiving a network state information request to request states of the first network through a second network; and
transmitting the visual information to a remote apparatus through the second network in response to the network state information request.

24. The network monitoring method of claim 13, further comprising displaying the visual information in a display device.

25. A network analyzing apparatus for analyzing a first network, comprising:
a network packet collector collecting packets of the first network;
at least two parameter storages in which the same value is stored only once; and
an attack type identifier generator generating an attack type identifier of a packet according to whether or not the value of each parameter of the packet is already stored in the parameter storages.

26. The network analyzing apparatus of claim 25, further comprising:
at least one attack packet storage in which packets are stored according to types of attack; and
a packet storing controller storing the packet in the attack packet storage according to the attack type identifier.

27. An attack type identifying method for identifying an attack type of a packet on a first network, comprising:
collecting packets of the first network; and
generating an attack type identifier of a packet according to whether or not the value of each parameter of the packet is already stored in parameter storages in which the same value is stored only once.

28. A packet classifying method for classifying packets on a first network according to attack type, comprising:
collecting packets of the first network;
generating an attack type identifier of a packet according to whether or not the values of each parameter of the packet are already stored in parameter storages in which the same value is stored only once; and
storing the packet in an attack packet storage according to the attack type identifier.
